(19) United States
(12) Patent Application Publication
(10) Pub. No.: US 2014/0054324 A1
(43) Pub. Date: Feb. 27, 2014

(54) UPRIGHT SQUEEZE FOAMER

(71) Applicant: Arminak & Associates, LLC, Azusa, CA (US)

(72) Inventor: Armin Arminak, Pasadena, CA (US)

(21) Appl. No.: 14/021,005

(22) Filed: Sep. 9, 2013

Related U.S. Application Data
(63) Continuation of application No. PCT/US2013/054523, filed on Aug. 12, 2013.
(60) Provisional application No. 61/691,427, filed on Aug. 21, 2012.

(51) Int. Cl. B67D 7/76; B65D 37/00

(52) U.S. Cl. CPC B05B 11/3087
USPC 222/190; 222/211

(57) ABSTRACT

A foamer for use in dispensing a liquid product with a foam consistency. The foamer including a dispensing cover defining a foam outlet, a closure including a valve seat and being assembled with the dispensing cover, a mesh screen constructed and arranged for receiving a mixture of liquid product and air and being received by the closure and a housing assembled with the closure. The housing including a valve seal which is constructed and arranged to cooperate with the valve seat for managing air flow and a air channel insert which is received by the housing for directing air into a flow of liquid product.

### CROSS REFERENCE TO RELATED APPLICATIONS

This application is a continuation of International Application No. PCT/US2013/054523 filed Aug. 12, 2013, which claims the benefit of U.S. Provisional Application No. 61/691,427 filed Aug. 21, 2012, which are hereby incorporated by reference.

### BACKGROUND

Various dispensing systems have been developed for dispensing a flowable product by means of manual actuation. The flowable product may be any one of a variety of health and beauty aid products or any one of a variety of home, kitchen and bath cleaning products. The type of manual actuation depends primarily on the construction of the dispensing system. Aerosols and similar pressurized containers are usually manually actuated by depressing a button. Dispensing systems employing a plunger construction are usually manually actuated by (downwardly) depressing an upwardly-extending actuator stem or post, often fitted with an ergonomic actuator. Also typical of such plunger constructions is the dispensing of the product out through the ergonomic actuator. This is similar to how an aerosol mist is dispensed out through an opening in the button which is depressed. This is also similar to how a spray mist would be dispensed. A flowable product may be dispensed as a mist, a spray, a liquid, a gel or a foam. While this listing may not be exhaustive, it does include the more common flowable product forms, compositions and consistencies.

The dispensing system constructions mentioned above each involve some type of direct manual manipulation of the dispensing mechanism. Even if one simply removes a threaded cap and pours out a portion of the product, there is still direct manual manipulation of the threaded cap. An alternative way of dispensing a flowable product is to provide a pliable container for the product and apply a manual squeezing force on the outer wall of the container in order to increase the interior pressure. This increased interior pressure forces a portion of whatever product is in the container to be dispensed through a dispensing outlet. While there is direct manual manipulation of the container wall, it is the interior pressure and the flow of air and product which actuate the dispensing structure and open any internal valves.

This general type or style of squeeze dispenser may be used to dispense product as a liquid or may be used to dispense the product as a foam composition or consistency which is an aerated mixture of liquid and air. The focus of the present disclosure, as shown by the exemplary embodiment, is directed to an upright squeeze foamer. However, some of the primary component parts are constructed and arranged in such a way as to facilitate their use in a related, upright squeeze dispenser for dispensing the product as a liquid rather than as a foam. This liquid dispenser is disclosed herein as a related embodiment.

### SUMMARY

The disclosed foam-dispensing system uses a pliable container (i.e. a squeeze bottle) for containing and storage of a liquid product. While the viscosity of the liquid product may vary based in part on its temperature, the use of “liquid” herein refers to alcohol-based products and other flowable products whose room temperature viscosity (μ) is preferably in the range of approximately between 1.0 centipoise and 150 centipoise. This range allows the selected liquid product to flow, to mix and to be dispensed with a foam consistency by way of the disclosed foam-dispensing system.

The term “system”, as used herein, refers to the combination of the container, the product which is placed in the container and the dispensing mechanism which is attached to the container. The “system” is also referred to as a “squeeze foamer”, due to the use of a squeezing force on the pliable wall of the container. One approach for attachment of the dispensing mechanism to the container is to provide a threaded neck on the container and threadedly connect the dispensing mechanism. A dip tube is typically extended into the product so as to be able to draw product into the dispensing mechanism. The dispensing mechanism is referred to herein as a “foamer”. The referenced viscosity range for the product encompasses a number of different liquid products such as liquid soap, shaving cream, cleaning preparations, and hygiene products, to name simply a few of the possibilities.

One consideration in the design and construction of a foamer of the type generally discussed above is its cost and this relates in part to the number of component parts and the material expense for those component parts. Another consideration is the quality of the foam which is produced and dispensed. The produced foam needs to have some degree of fluidity to be easily dispensed. However, too much product in the mixture with air may result in a foam which is too runny and will not remain where it is applied. Too much air in the mixture can affect the fluidity of the foam and may cause the foam to be too dry. Controlling the volumetric ratio of liquid product and air is important in controlling the quality of the foam which is dispensed. A still further consideration is the reliability of the foamer construction. Included as part of this consideration is the integrity of any interior valves and their sealing effectiveness. A still further consideration is the ease of assembly. This may relate in part to the number of component parts, but also relates to the construction of those component parts and their manner of assembly and interfit with one another.

A still further consideration is the range of products which the foamer can accommodate. This degree of accommodation depends in part on the product viscosity and in part on the design of the component parts. The focus here is on the dimensions, sizes, lengths, etc. which influence the flow of liquid product and air. With these considerations in mind, the disclosed embodiment provides an efficient and reliable structure which produces and dispenses an acceptable foam consistency for the product. The limited number of component parts assemble easily without the need for any bonding, ultrasonic welding or the use of threaded fasteners. The valving for the air flow is accomplished by a unitary, single-piece component. A unique air channel insert provides a plurality of air flows into the liquid product which is flowing from the container. The plurality of air flows facilitates mixing of the air and liquid product before the mixture is pushed through a mesh insert for foam aeration. Use of the phrase “foam aeration” describes the process of pushing an air and liquid product mixture through a mesh screen. This mixture may be the two (2) constituents as initially mixed or may be the two (2) constituents after a first pass through a coarse mesh.

### BRIEF DESCRIPTION OF THE DRAWINGS

FIG. 1 is a side elevational view, in partial section, of an upright squeeze foamer according to the preferred embodiment.

FIG. 2 is a side elevational view of the foamer which comprises one component part of the FIG. 1 upright squeeze foamer.

FIG. 3 is a front elevational view of the FIG. 2 foamer.

FIG. 4 is a rear elevational view of the FIG. 2 foamer.

FIG. 5 is a perspective view of the FIG. 2 foamer.

FIG. 6 is a top plan view of the FIG. 2 foamer.

FIG. 7 is a front elevational view, in full section, of the FIG. 2 foamer based upon cutting plane 7-7 as shown in FIG. 6.

FIG. 8 is a side elevational view, in full section, of the FIG. 2 foamer based upon cutting plane 8-8 as shown in FIG. 6.

FIG. 9 is an angled side elevational view, in full section, of the FIG. 2 foamer based upon cutting plane 9-9 as shown in FIG. 6.

FIG. 10. is an enlarged, side elevational view, in full section, of the FIG. 2 foamer in a closed condition with only a portion of the dip tube.

FIG. 11 is a front elevational view of a dispensing cover which comprises one component part of the FIG. 2 foamer.

FIG. 12 is a top plan view of the FIG. 11 dispensing cover.

FIG. 13 is a side elevational view, in full section, of the FIG. 11 dispensing cover based upon cutting plane 13-13 as shown in FIG. 12.

FIG. 14 is a perspective view of a closure which comprises one component part of the FIG. 2 foamer.

FIG. 15 is a front elevational view of the FIG. 14 closure.

FIG. 16 is a top plan view of the FIG. 14 closure.

FIG. 17 is a front elevational view, in full section, of the FIG. 14 closure based upon cutting plane 17-17 in FIG. 16.

FIG. 18 is an angled side elevational view, in full section, of the FIG. 14 closure based upon cutting plane 18-18 in FIG. 16.

FIG. 19 is a front elevational view of a mesh insert which comprises one component part of the FIG. 2 foamer.

FIG. 20 is a top plan view of the FIG. 19 mesh insert.

FIG. 21 is a front elevational view, in full section, of the FIG. 19 mesh insert based upon cutting plane 21-21 as shown in FIG. 20.

FIG. 22 is a perspective view of a housing which comprises one component part of the FIG. 2 foamer.

FIG. 23 is a front elevational view of the FIG. 22 housing.

FIG. 24 is a top plan view of the FIG. 22 housing.

FIG. 25 is a front elevational view, in full section, of the FIG. 22 housing based upon cutting plane 25-25 as shown in FIG. 24.

FIG. 26 is a perspective view of an air channel insert which comprises one component part of the FIG. 2 foamer.

FIG. 27 is a front elevational view of the FIG. 26 air channel insert.

FIG. 28 is a top plan view of the FIG. 26 air channel insert.

FIG. 29 is a front elevational view, in full section, of the FIG. 26 air channel insert based upon cutting plane 29-29 as shown in FIG. 28.

FIG. 30 is a side elevational view, in full section, of a squeeze container for dispensing liquid according to another embodiment of the present disclosure.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

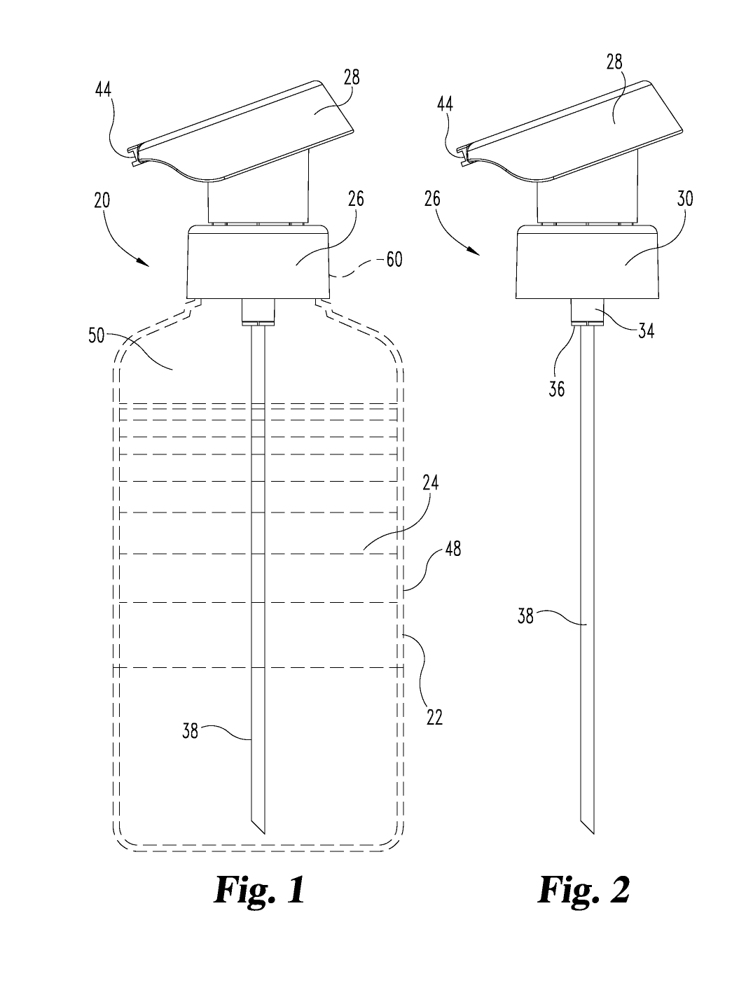

Referring to FIG. 1 there is illustrated an upright squeeze foamer 20 which includes container 22, a supply of liquid product 24 and foamer 26. In terms of production, marketing and sales for squeeze foamer 20 and its constituents, a completed squeeze foamer 20, filled with product 24, could be sold in that completed condition to a distributor, to a wholesaler or to a discount or retail outlet. The container 22 and foamer 26 could be sold as a combination, without product, to a filler. Another option, when the filler has the container 22 supplied by another entity, is to sell only the foamer 26. FIG. 1 shows the entire upright squeeze foamer 20 including container 22 and liquid product 24. However, the focus of this disclosure and of the exemplary embodiment is on the foamer 26.

The exemplary embodiment, as illustrated herein, is described as being an “upright” squeeze foamer. In order to properly orient the disclosed upright squeeze foamer, its normal, not in use condition is with the base of the container resting on a shelf, countertop or similar substantially horizontal surface. The dispensing cover 28 is thus oriented, in this condition, as the highest or uppermost portion of the upright squeeze foamer. The upright squeeze foamer, in this condition, has a longitudinal axis which is substantially vertical. The use of “upright” also refers to the fact that even if the container is turned or tilted when being squeezed, the dispensing cover 28 would typically remain axially higher than the base of the container. In brief, the use of “upright” is intended to also clarify and to differentiate this general style of dispenser from that category of dispensers which is typically referred to as “inverted”.

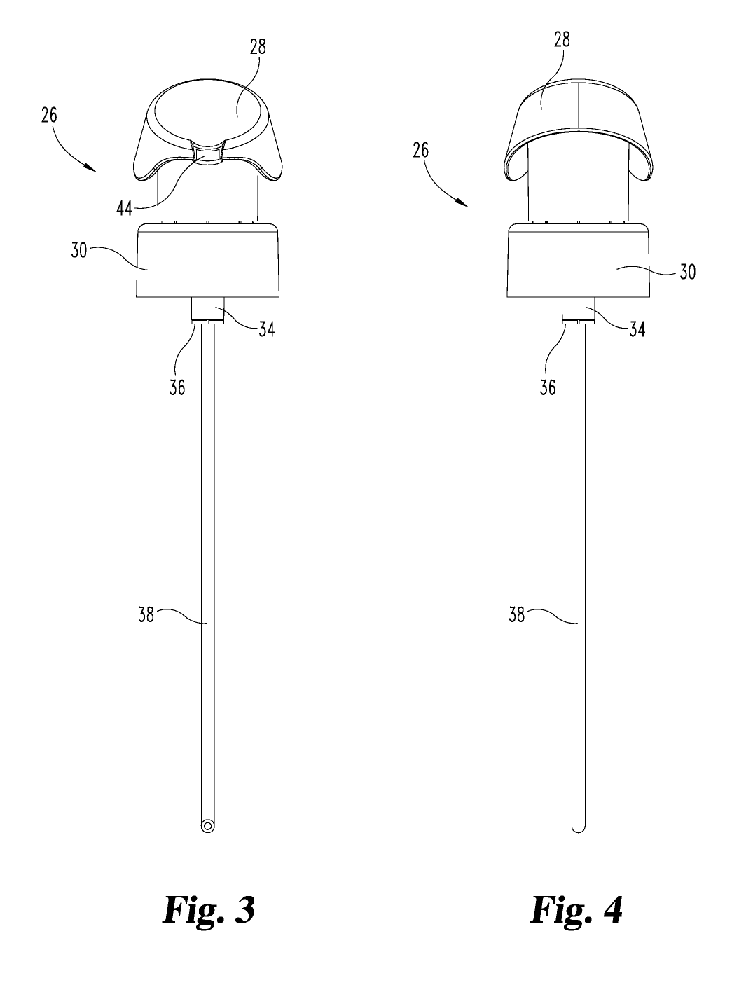

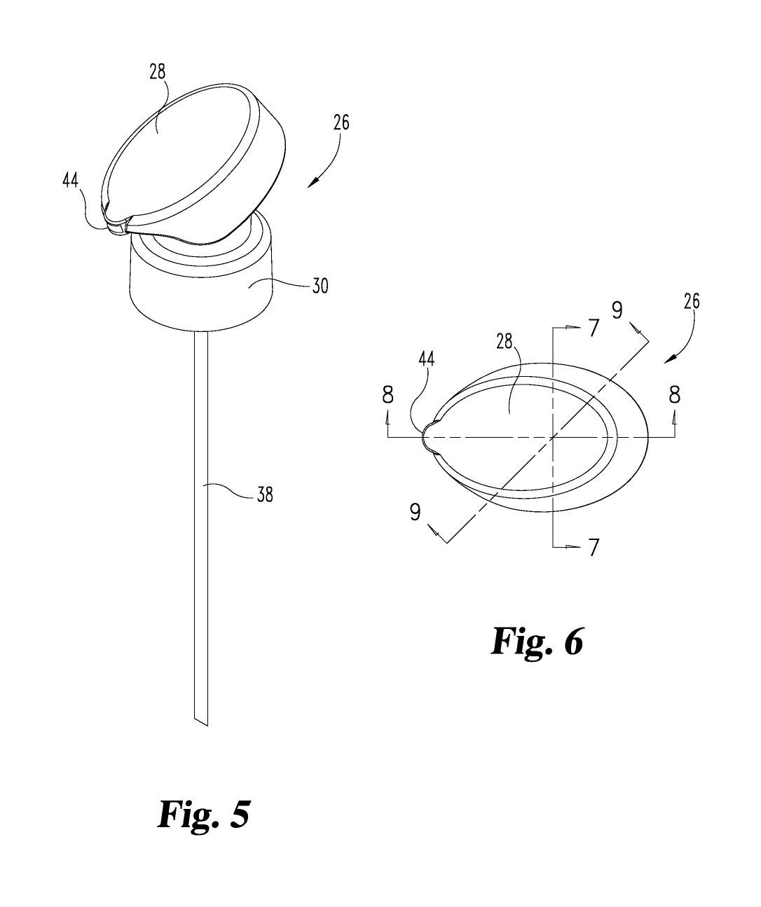

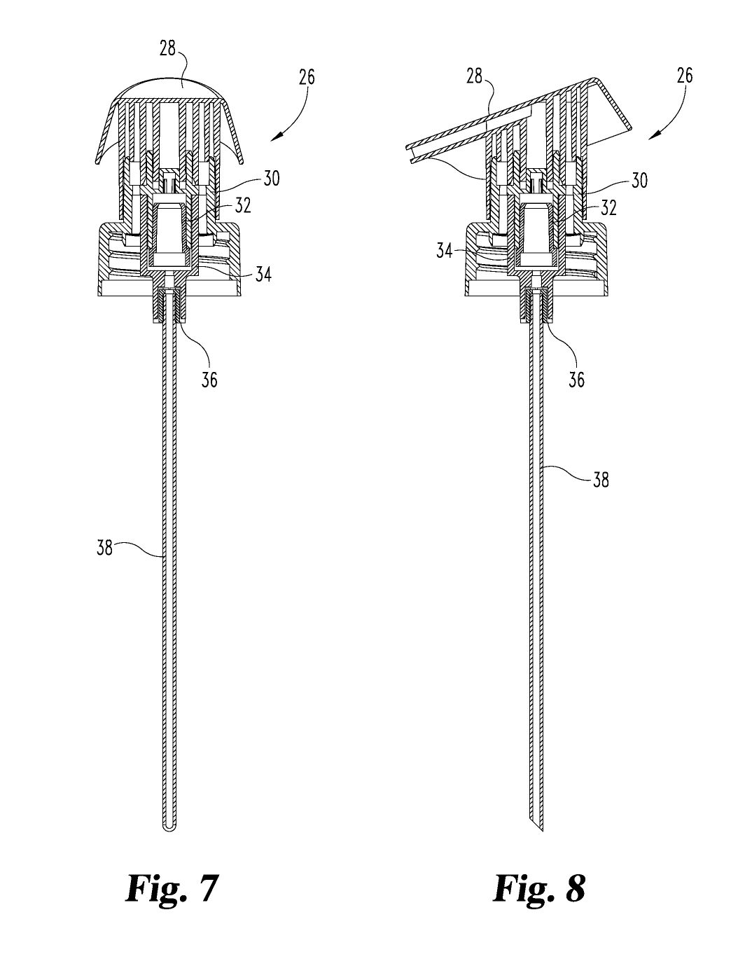

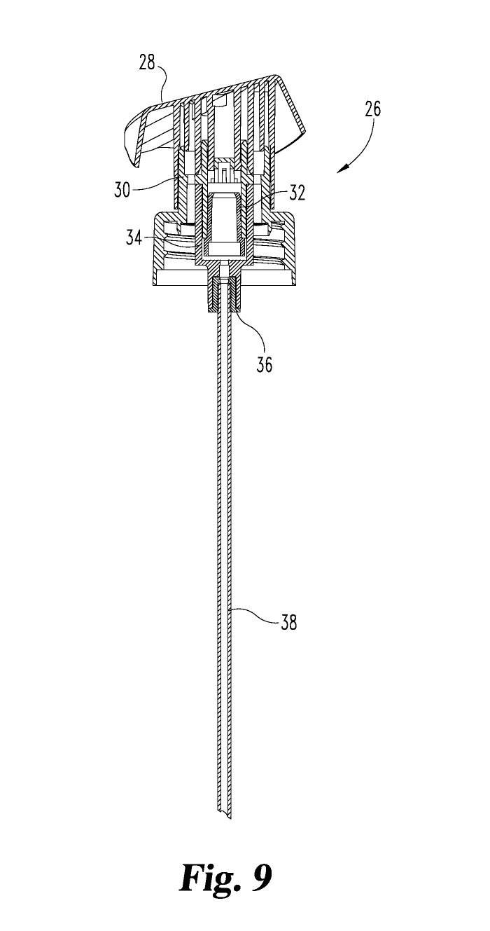

Referring now to FIGS. 2-10, the foamer 26 is illustrated in greater detail. Foamer 26 includes a dispensing cover 28, closure 30, mesh insert 32, housing 34, air channel insert 36 and dip tube 38. These component parts 28, 30, 32, 34, 36 and 38 are assembled together without using any adhesive, bonding agents, threaded fasteners or the use of ultrasonic welding. The dispensing cover 28 defines a dispensing channel 39 which arranged in a first section 40 and a second section 42. The open dispensing outlet 44 is at the distal end of the second section 42. Closure 30 is assembled up into corresponding annular grooves and spaces of dispensing cover 28. The mesh insert 32 is received by the closure 30 with a snap fit using annular beads. Closure 30 includes a generally cylindrical portion 46 which is received by the housing 34, also with a snap fit. The air channel insert 36 is received by the housing 34, by means of a press fit or interference fit assembly. The dip tube 38 is received by the air channel insert 36, also by means of a press fit or interference fit assembly. With the exception of the upper portion of the dispensing cover 28, each component part of foamer 26 is an annular, generally cylindrical component part or component feature. Further, except for dispensing cover 28, each component part 30, 32, 34, 36, and 38 of foamer 26 is generally symmetrical about a diametrical cutting plane.

Briefly, the manual squeezing of the container 22 so as to draw generally opposing portions of the pliable sidewall 48 closer together (see FIG. 1), causes an increase in the interior pressure. This increase in the interior pressure creates an air flow and creates a flow of the liquid product 24 upwardly through the dip tube 38. Referring again to FIG. 1, there is an air pocket 50 in container 22 which is located above the volume of liquid product 24. As the opposing portions of the container sidewall 48 are squeezed together, the interior volume of the container is reduced and the interior forces which are generated cause the trapped air to try and find an exit path of least resistance. This interior pressure also causes the liquid to try and find an exit path of least resistance. These two (2) flows of air and liquid product are combined and pushed through the mesh insert 32 thereby creating a foam consistency for the liquid product 24. The foam exits via the dispensing channel 39 travelling first up through first section 40 before turning into section 42 and ultimately flowing out through dispensing outlet 44.

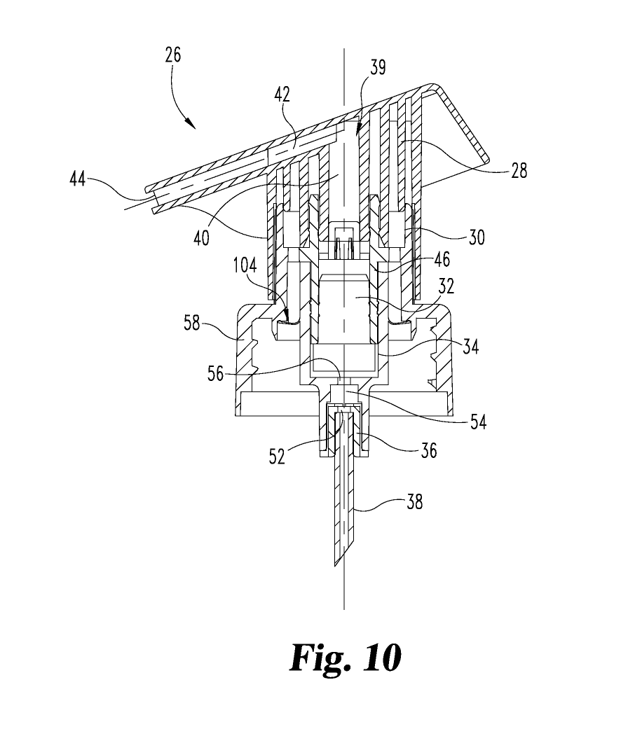

With continued reference to FIG. 10, an enlarged view of foamer 26 is illustrated. Only a portion of the dip tube 38 is shown in order to focus on the details of the other component parts. The specific flow path for the air is in and up through air channel insert 36. The center of air channel insert 36 is open for receipt of the upper end of the hollow dip tube 38. The top, centered opening 52 receives an upward flow of liquid and the flow of air is arranged into four (4) transverse flow paths which intersect the upward flow of liquid and these two (2) substances mix in area 54 before proceeding, as a mixture, through opening 56 and into the mesh insert 32.

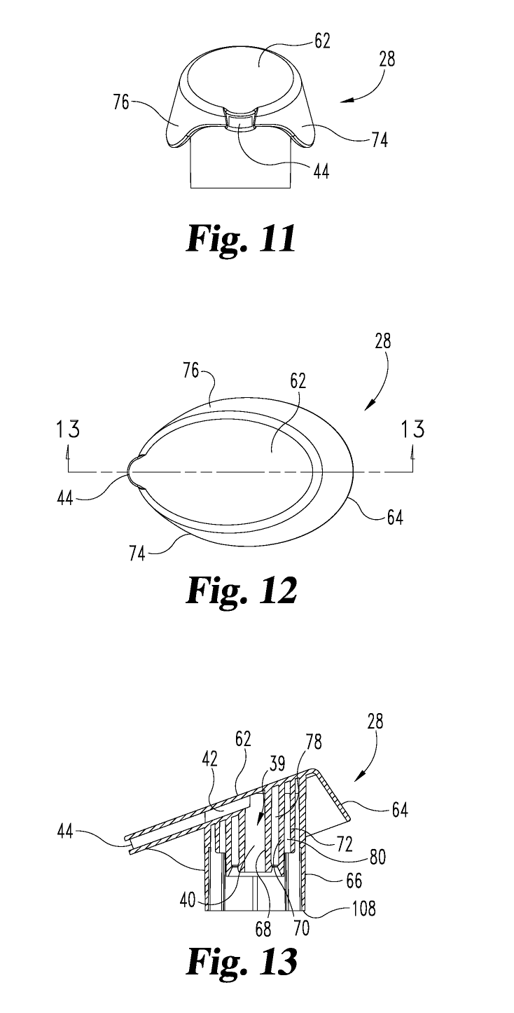

The closure 30 includes a lower, generally cylindrical skirt 58 which is internally threaded for threaded connection to the threaded neck 60 of container 22. The exemplary embodiment shows internal threads on the skirt 58 and there are cooperating external threads on the neck 60. However, it is contemplated that this form of threaded engagement could be reversed. Alternatively, the foamer 26 and container 22 could be securely assembled together, into a leak-free combination, by means of a snap-fit combination or an interference fit. Techniques such as the use of ultrasonic welding or the use of adhesives are not suitable since as a practical matter they can only be employed after the container is filled with liquid product. Dispensing cover 28, as a separate component part, is illustrated in FIGS. 11-13.

Dispensing cover 28 includes an incline top panel 62, a flared rear skirt 64, an outer, generally cylindrical sidewall 66 and a series of generally cylindrical, generally concentric interior walls 68, 70 and 72. Rear skirt 64 extends around top panel 62 in a contoured manner, evolving into and becoming side panels 74 and 76 which terminate adjacent dispensing outlet 44.

Wall 68 defines first section 40 and a combination of walls 68 and 70 define a generally cylindrical channel 78 which receives, with a closely toleranced, sliding fit, the upper end of cylindrical portion 46 of closure 30. The combination of wall 72 and sidewall 76 define a generally cylindrical channel 80 which receives, with a closely toleranced, sliding fit, another wall portion 82 of closure 30. The need for a sliding fit of the cover 28 relative to the closure 30 is to be able to use the cover to open and close the foam exit openings 84 which are defined by closure 30. The cover 28 is constructed and arranged relative to closure 30 so as to have limited axial travel. In the UP position of cover 28 the foam exit openings 84 (see FIGS. 16 and 18) are open, allowing the foam to flow into first section 40. In the DOWN position of cover 28, the lower end or face of wall 68 is used to cover over and block those defined foam exit openings 84. This UP (open)/DOWN (closed) feature is used for shipping of the upright squeeze foamer 20 and can be used by the end user when the upright squeeze foamer 20 is not being used for dispensing foam.

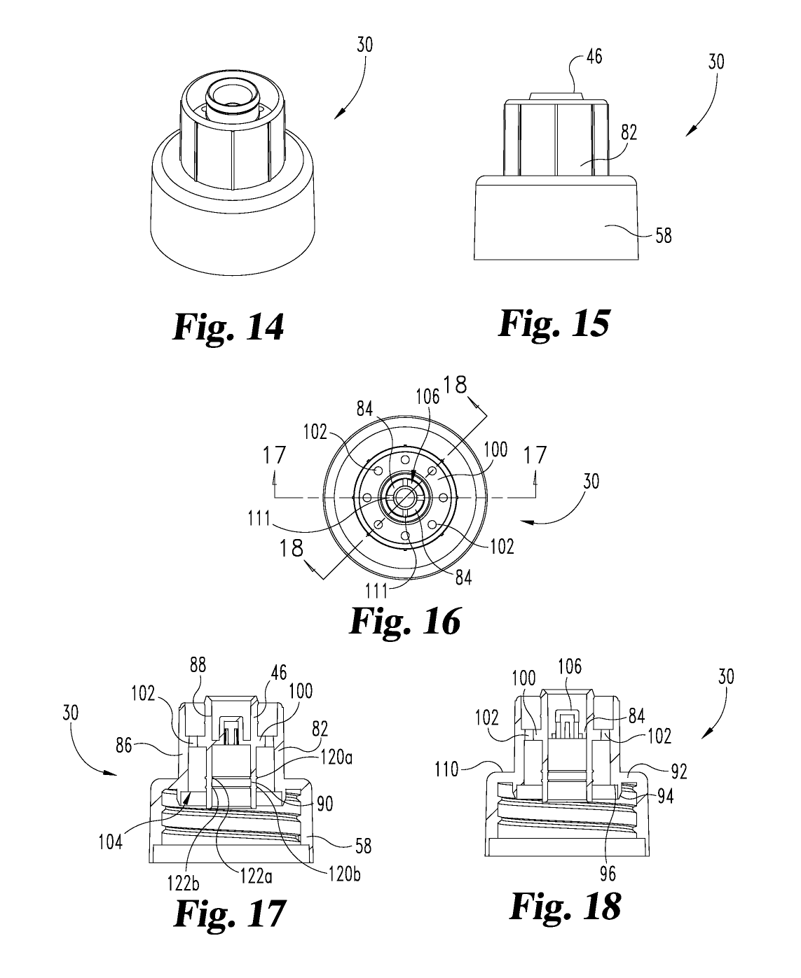

Closure 30, has a separate component part, as illustrated in FIGS. 14-18. Closure 30 includes a generally cylindrical upper portion 86 which is defined by wall portion 82 and radially inwardly an inner wall portion 88 which is defined by cylindrical portion 46. Skirt 58, upper portion 86 and inner wall portion 88 are each generally concentric with each other. The lower part 90 of inner wall portion 88 which is also generally cylindrical, receives mesh insert 32 with a snap-over or snap-fit assembly according to the exemplary embodiment. As an alternative, the lower part 90 may receive mesh insert 32 with a snap fit. The insert 32 includes an annular, radially outward abutment ledge 91 for controlling the axial depth of insertion of the mesh insert 32 into the generally cylindrical chamber defined by lower part 90. Although the exemplary embodiment includes a snap-over interfit employing annular ribs, there is still a need to prevent over insertion and thus the reason to include ledge 91.

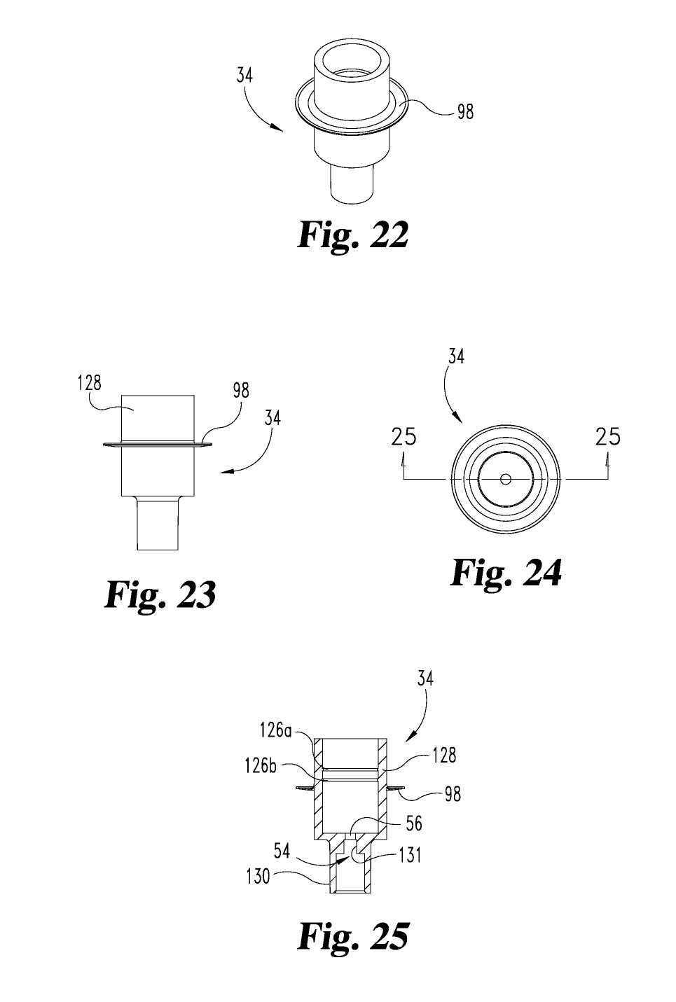

Radial shelf 92 provides a transition structure between upper portion 86 and skirt 58. The lower, inner surface of shelf 92 includes a depending, generally cylindrical wall 94. The inner surface of wall 94 is radially outwardly offset from the inner surface of wall portion 82 so as to define an annular surface 96. Surface 96 becomes a valve seat in cooperation with the flexible, annular valve seal 98 of housing 34. The combination of valve seal 98 and valve seat 96 provides an air flow valve for the intake of make-up air back into container 22. As one aspect of the overall design efficiency, integrally molding valve seal 98 as part of housing 34 (see FIGS. 22-25) reduces the total component part count by one (1).

Upper portion 86 and inner wall portion 88 are connected by shelf 100. Shelf 100 defines a plurality of air flow apertures 102 for the flow of make-up air into container 22 from the outside atmosphere. In the exemplary embodiment there are eight (8) equally-spaced apertures 102. When the squeezing force on the container is released, the pliable nature of the sidewall 48 causes the container shape to substantially return to its starting shape. This in turn creates an internal suction force which pulls, with a hinged pivoting movement, the outer portion of the valve seal 98 off of valve seat 96 so as to create an air flow passageway 104 between seal 98 and seat 96 (see FIG. 10). A level of suction force remains until the interior pressure is restored to generally atmospheric pressure. This means that outside air is drawn in via the apertures 102 until the internal pressure within container 22 is restored to substantially atmospheric pressure. As the atmospheric pressure is restored, the valve seal 98 closes back against valve seat 96 due to its elastomeric resiliency and the absence of any sufficient suction pressure to pull or retain valve seal 98 in an open position. The positive pressure which is created by the squeezing action forces the valve seal 98 against the valve seat 96 so that when producing foam, the air flow is through air channel insert 36 and not through any flow passageway 104 nor through any of the apertures 102.

Foam control valve 106 constitutes a valve structure in the interior of inner wall portion 88 in the vicinity of, though inwardly of, shelf 100. As described, when the dispensing cover 28 is in the up and open condition, foam is able to flow through the foam control valve 106 and enter the first section 40 of the dispensing channel 39 (see FIG. 13). When the dispensing cover 28 is in the down and closed condition, foam is unable to flow into first section 40. A small snap-over lip or annular bead arrangement between dispensing cover 28 and closure 30 prevents pull-off of dispensing cover 28 during normal handling and use. There is an abutment structure between these two (2) components which limits the extent of upward travel of dispensing cover 28 relative to closure 30 during normal handling and use. In the downward direction, the travel of dispensing closure 28 is controlled by abutment between the lower edge 108 of sidewall 66 and the upper surface 110 of radial shelf 92. Foam control valve 106 includes a four-spoke construction wherein the four (4) radial spokes 111 are equally-spaced and each adjacent pair, in combination with portion 46, defines one (1) of the four (4) equally-spaced foam exit openings 84.

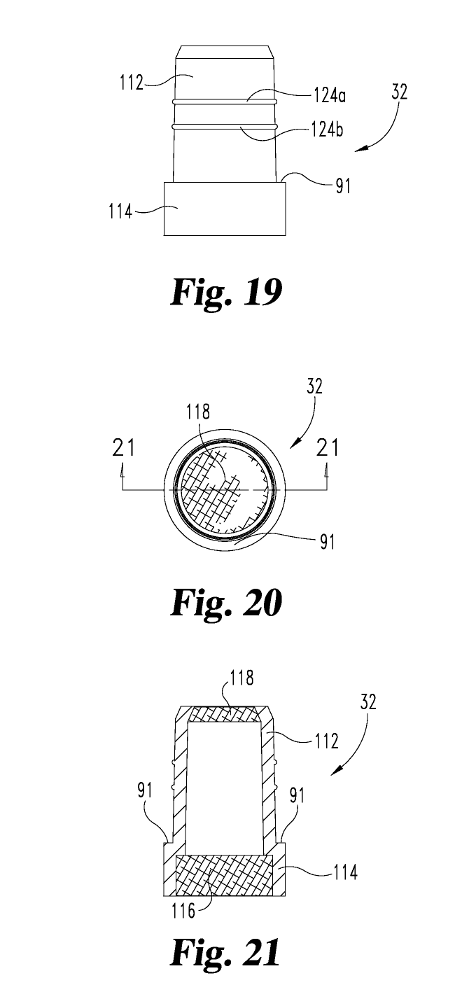

Mesh insert 32, as a separate component part, is illustrated in FIGS. 19-21. Mesh insert 32 includes a generally cylindrical upper portion 112 and a generally cylindrical, larger diameter, lower portion 114. This diameter size difference creates ledge 91. Lower portion 114 receives and retains a coarse mesh screen 116 for the liquid product and air mixture to pass through for a first stage of aeration and coarse foaming. Upper portion 112 receives and retains a fine mesh screen 118 for the first stage foam to pass through for a final stage aeration and creation of the foam consistency which will be dispensed.

In the exemplary embodiment two (2) mesh screens are provided and these two (2) mesh screens 116 and 118 are incorporated into mesh insert 32. Alternatively, additional mesh screens can be used or the foamer could include a single mesh screen. Further, in addition to or in lieu of insert 32, the mesh screens can be integrated into other component parts of the foamer, such as into dispensing cover 28, closure 30 and/or housing 34. This integration may be an integrally molded combination or a snap-in assembly of the mesh screen into the other part or a press-in or interference fit assembly.

As described, one assembly option is to use a press-fit or interference-fit relationship. This involves closely-controlled tolerances, but with plastic parts, there is greater tolerancing latitude due to the “give” associated with plastic component parts. Another assembly feature, and the one selected for the exemplary embodiment, is to add snap-over ribs to the respective parts. These ribs which are preferably annular in shape can be used independently of any interference fit or can be used in combination with a interference fit. In the exemplary embodiment, lower part 90 of closure 30 includes two (2) spaced-apart, snap-over ribs 120a and 120b on the outside surface and two (2) snap-over ribs 122a and 122b on the inside surface.

The mating component parts include similar snap-over annular ribs for a secure, snap-fit assembly. In the case of the mesh insert 32, its pair of spaced-apart annular ribs 124a and 124b are on the outer surface of upper portion 112. Upper portion 112 has a snap-fit assembly into the interior of lower portion 90, wherein ribs 122a and 122b cooperate with ribs 124a and 124b. In the case of housing 34, its pair of spaced-apart annular ribs 126a and 126b are on the inside surface of upper body 128, wherein ribs 120a and 120b cooperate with ribs 126a and 126b.

Housing 34, has a separate component part, as illustrated in FIGS. 22-25. Housing 34 includes, in addition to area 54, opening 56, valve seal 98, ribs 126a and 126b, and upper body 128, a lower portion 130 which defines area 54. Lower portion 130 and upper portion 128 are each generally cylindrical and are generally concentric to each other. At the time of assembly between housing 34 and closure 30, the upper end of wall 128 abuts up against the lower surface of shelf 100. Shelf 132 separates the upper portion 128 and lower portion 130 and defines opening 56. Valve seal 98 is an annular member which is generally concentric with upper portion 128. The valve seal 98 is relatively thin and this characteristic contributes to its flexibility for sealing and its inherent resiliency for returning to its normal or original condition. Lower portion 130 includes a generally cylindrical and generally concentric offset wall 131 which helps direct the axial air flows to turn radially inwardly.

The construction and arrangement of housing 34 provides a unique degree of efficiency by the unitary integration (i.e. a single-piece construction) of the valve seal 98. This valve seal 98 also functions as a two-way component to close off air flow when producing foam (or dispensing liquid) and to open up to let in make-up air.

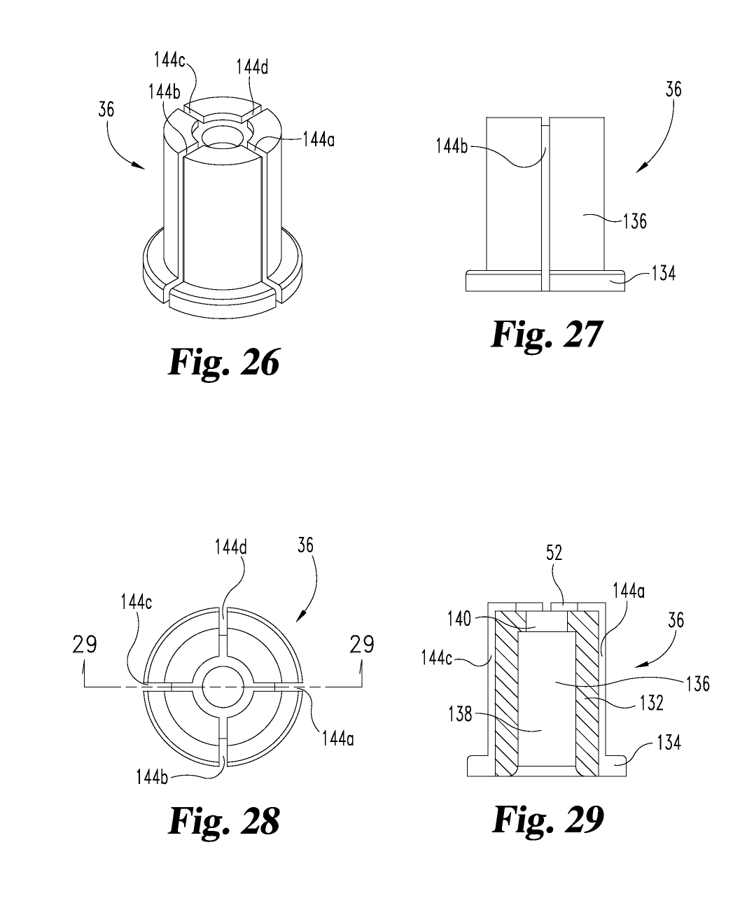

Air channel insert 36, as a separate component part, is illustrated in FIGS. 26-29. Air channel insert 36 receives the dip tube and is received by the lower portion 130 of housing 34. These assemblies are each based on having a suitable press-fit or interference fit such that the dip tube remains in position and such that the air channel insert remains in position. Air channel insert 36 includes a generally cylindrical, hollow body 32 with a generally cylindrical base 134. Base 134 is generally concentric with body 132. The hollow interior 136 of body 132 includes hollow portions 138 and 140 and the top, centered opening 52.

In the exemplary embodiment four (4) continuous grooves 144a, 144b, 144c and 144d are defined by the base 134 and by the body 132, as is illustrated. Each groove, starting with the outer surface of the base 134, extends radially inwardly through and across the base 134 and into the surface of body 132. Each groove then proceeds axially upward along the length of the body 132 and then each groove makes essentially a right turn in a inwardly radial direction into and across the upper surface 146 of body 132 until intersecting hollow portion 142. When the air channel insert 36 is assembled into the housing, the portion of each groove which extends the length of body 132 is enclosed. The upper portion of air channel insert 36 is covered over in part by offset wall 131 and this helps to turn the four air flow paths inwardly. The point of air entry into each groove is at the base and the point of exit for mixing with the flow of liquid product 24 is adjacent upper surface 146. The direction of the air flow exiting into the area 54 and the multiple streams of air flow create desired turbulence for better mixing with the flow of liquid product before the mixture enters the mesh insert 32.

The character of the foam which is produced focuses first on the mixture ratio of liquid product and air. Next, the nature of the mesh insert, including the number and style of mesh screens help to define the foam consistency for that particular mixture. If there is too much liquid product for the volume of air which is supplied, then the foam consistency may be too runny. If there is too much air in proportion to the liquid product, then the foam consistency is too dry and may be too stiff. Either “extreme” is considered to be less than ideal and if too extreme, unacceptable.

When the container is squeezed, the internal pressure, which is the same throughout the inside of the squeeze foamer, influences the amount of air which is forced into the air channel insert. This internal pressure also influences the amount of liquid product which is delivered by the dip tube. Other influencing factors include surface areas and the cross-sectional area of such features as channels, grooves, apertures, openings and passageways. If we assume that the amount of liquid product flowing through the interior of the air channel insert (i.e. the volumetric flow rate) is fixed or at least known based on the specifics of the container, the dip tube design and the liquid product viscosity, then changing the proportion of air may change the foam consistency. The proportion of air is able to be controlled by the size and number of grooves 144a, 144b, 144c and 144d.

The exemplary embodiment is constructed and arranged such that the liquid product volumetric flow rate is set at a mid-range or median value. Further, the exemplary embodiment of air channel insert 36 results in a foam consistency which is deemed preferred. One advantage in terms of the mixing is to create each air flow groove 144a, 144b, 144c and 144d as a relatively thin groove and in order to provide sufficient air flow, provide four (4) such grooves. This allows smaller, individual flow streams, but also a larger number of flow streams both of which help the mixing of air into the flow of liquid product.

If the intended application changes to something which may benefit from a different foam consistency, or if a different liquid product is selected which may have a different viscosity or foaming characteristic, the only change required to still retain something close to a preferred or ideal foam consistency is to install a different air channel insert 36. Selection of a different air channel insert 36 could also be applied when the squeeze container is going to be used for liquid and not foam. As explained, by simply closing off the air grooves liquid is dispensed. The use of “different” as set forth above means an air channel insert 36 which introduces either more air or less air (or none) into the flow of liquid product.

In use, the initial squeezing of the pliable wall of the container 22 creates an internal pressure which forces the flow of liquid product up the dip tube and the flow of air into the grooves 144a, 144b, 144c and 144d of the air channel insert 36. The internal pressure forces valve seal 98 against valve seat 96 so that the air cannot exit to atmosphere via that route. The flows of air and liquid product mix in area 54 and proceed into the mesh insert 32. The mesh screens aerate and mix the air and liquid into the desired foam consistency. This desired foam is then pushed out of the squeeze foamer 20 via dispensing channel 39 and dispensing outlet 44.

When the squeezing force is released, the valve seal 98 opens due to internal suction as the container tries to return to its prior condition and needs to draw in outside air to be able to do so. The action and reaction of the pliable container is what would be expected from a “squeeze bottle” design. The differences and the novelty of the disclosed embodiment are found in the construction and arrangement of the component parts which comprise foamer 26.

Disclosed herein are several snap-fit and/or interference fit assemblies between two (2) component parts or at least between portions of the two (2) component parts. Typically these component part portions are generally cylindrical and include or define some type of assembly structure. Described thus far are raised annular ribs, usually a plurality, and recessed annular grooves or what would be described as detents in a more functional sense.

It is to be understood that virtually any assembly technique or combination may be used for virtually any portion of the exemplary embodiments. These options include the following. One option is to provide one (1) or more raised annular ribs on one (1) part and one (1) or more recessed annular grooves on the other part. The snap-fit of the ribs into the grooves, similar to a ball and detent, helps to secure the assembly of these two (2) component parts. This assembly technique may be used with closely sized parts which may also provide a sliding fit or even an interference fit in addition to the rib-groove interfit.

Another option is to provide only the one (1) or more raised annular ribs on one of the parts. The mating part simply provides a closely sized and similarly shaped surface which creates an interference fit or perhaps a close sliding fit relative to the raised annular ribs. When an interference fit exists, this interference fit actually anchors the two (2) parts together. With plastic parts, and depending on the degree of interference, the ribs may actually “indent” into the other part thereby adding a type of interlock to the assembly.

A still further option is to provide one (1) or more raised annular ribs on each part. This arrangement has the rib or ribs on one part snapping over one or more of the ribs on the other part. There is dimensional interference based in the diameter sizes of the ribs requiring axial force for the snap-together or snap-over assembly of the two (2) component parts.

In a very basic sense and as a very broad generalization, an upright, liquid squeeze bottle and an upright foamer differ in primarily two (2) ways. The first way is that the liquid squeeze bottle does not dispense any noticeable amount of air and certainly not any noticeable amount of air which is mixed in or aerated along with the liquid product. The second way or second difference is that there is no need for a mesh insert in order to aerate and help mix the liquid product and air.

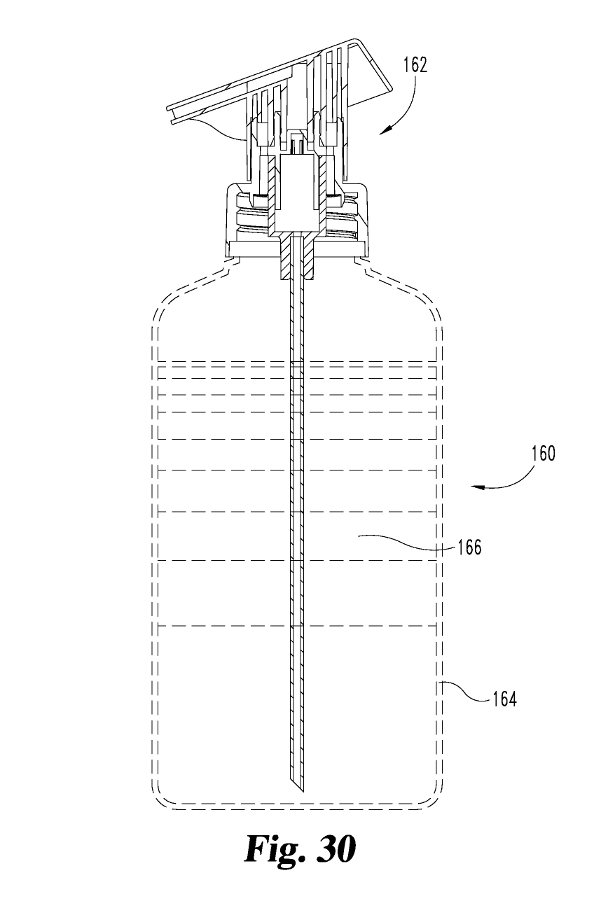

An upright, liquid squeeze bottle 160 is illustrated in FIG. 30 and includes a dispensing subassembly 162, a container (or bottle) 164 and liquid product 166. As will be seen or as can be determined by a comparison of FIGS. 30 and 10, for example, the dispensing subassembly 162, as compared to foamer 26, does not include either a mesh insert or an air channel insert. Otherwise, dispensing subassembly 162 is essentially the same as foamer 26. It would be necessary to resize the dip tube and housing if an air channel insert is not used. The only other likely modification or elimination would be to eliminate the snap-over ribs on the inside surface of the lower part 90 of the housing as there is no mesh insert to be assembled. This of coarse is optional.

A further variation which is contemplated by the present disclosure, so as to preclude the need for any resizing of the dip tube and/or housing, is to allow the air channel insert to be used, but simply block or close off each groove. For example, by not providing any grooves in the base, there would be no starting point for air flow and as a consequence, there would not be any air flow mixing with any of the liquid product. This arrangement would allow an easy conversion from foam to liquid or from liquid to foam based simply on the type of air channel insert used and including or eliminating the mesh insert.

In the exemplary embodiment all of the component parts of foamer 26 with the exception of the dip tube, are unitary, single-piece molded component parts which are fabricated out of a suitable thermoforming or thermosetting plastic. The preferred material for the mesh insert is nylon and the preferred material for the dip tube is polyethylene.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A foamer for use in dispensing a product with a foam consistency, said foamer comprising:
a dispensing cover defining a foam outlet;
a closure including a valve seat and being assembled with said dispensing cover;
a mesh screen constructed and arranged for receiving a mixture of liquid product and air and being positioned within said foamer;
a housing assembled with said closure, said housing including a valve seal which is constructed and arranged to cooperate with said valve seat for managing air flow; and
an air channel insert received by said housing for directing air into a flow of liquid product.

2. The foamer of claim 1 wherein said housing and said valve seal are integrated as a single-piece component.

3. The foamer of claim 1 wherein said closure includes a foam control valve with a plurality of foam flow openings.

4. The foamer of claim 1 wherein said dispensing cover is movable relative to said closure between an open condition and a closed condition.

5. The foamer of claim 1 wherein said mesh screen and said closure comprise a snap-fit assembly.

6. The foamer of claim 1 wherein said housing and said closure comprise a snap-fit assembly.

7. The foamer of claim 1 wherein said air channel insert defining a plurality of space-apart air grooves.

8. A foamer for use in dispensing a product with a foam consistency, said foamer comprising:
a dispensing cover defining a foam outlet;
a closure assembled with said dispensing cover;
a mesh screen constructed and arranged for receiving a mixture of liquid product and air and being positioned within said foamer;
a housing assembled with said closure; and
an air channel insert received by said housing for directing air into a flow of liquid product, said air channel insert defining a plurality of air grooves whose size and number are selectively variable in order to influence the air-liquid mix ratio.

9. The foamer of claim 8 wherein said housing and said valve seal are integrated as a single-piece component.

10. The foamer of claim 8 wherein said closure includes a foam control valve with a plurality of foam flow openings.

11. The foamer of claim 8 wherein said dispensing cover is movable relative to said closure between an open condition and a closed condition.

12. The foamer of claim 8 wherein said mesh screen and said closure comprise a snap-fit assembly.

13. The foamer of claim 8 wherein said housing and said closure comprise a snap-fit assembly.

14. The foamer of claim 8 wherein said closure and said housing cooperate to form an air-control valve.

15. A squeeze foamer for dispensing a product with a foam consistency, said squeeze foamer comprising:
a squeeze container;
a volume of liquid product received by said squeeze container;
a foamer comprising:
a dispensing cover defining a foam outlet;
a closure including a valve seat and being assembled with said dispensing cover;
a mesh screen constructed and arranged for receiving a mixture of liquid product and air and being positioned within said foamer;
a housing assembled with said closure, said housing including a valve seal which is constructed and arranged to cooperate with said valve seat for managing air flow; and
an air channel insert received by said housing for directing air into a flow of liquid product; and
a dip tube for routing liquid product from said squeeze container into said foamer.

16. The squeeze foamer of claim 15 wherein said housing and said valve seal are integrated as a single-piece component.

17. The squeeze foamer of claim 15 wherein said closure includes a foam control valve with a plurality of foam flow openings.

18. The squeeze foamer of claim 15 wherein said dispensing cover is movable relative to said closure between an open condition and a closed condition.

19. The squeeze foamer of claim 15 wherein said mesh screen and said closure comprise a snap-fit assembly.

20. The squeeze foamer of claim 15 wherein housing and said closure comprise a snap-fit assembly.

21. The squeeze foamer of claim 15 wherein said air channel insert defining a plurality of space-apart air grooves.

22. A squeeze foamer for dispensing a product with a foam consistency, said squeeze foamer comprising:
a squeeze container;
a volume of liquid product received by said squeeze container;
a foamer comprising:
a dispensing cover defining a foam outlet;
a closure assembled with said dispensing cover;
a mesh screen constructed and arranged for receiving a mixture of liquid product and air and being positioned within said foamer;
a housing assembled with said closure; and
an air channel insert received by said housing for directing air into a flow of liquid product, said air channel insert defining a plurality of air grooves whose size and number are selectively variable in order to influence the air-liquid mix ratio; and
a dip tube for routing liquid product from said squeeze container into said foamer.

23. The squeeze foamer of claim 22 wherein said housing and said valve seal are integrated as a single-piece component.

24. The squeeze foamer of claim 22 wherein said closure includes a foam control valve with a plurality of foam flow openings.

25. The squeeze foamer of claim 22 wherein said dispensing cover is movable relative to said closure between an open condition and a closed condition.

26. The squeeze foamer of claim 22 wherein said mesh screen and said closure comprise a snap-fit assembly.

27. The squeeze foamer of claim 22 wherein said housing and said closure comprise a snap-fit assembly.

28. The squeeze foamer of claim 22 wherein said closure and said housing cooperate to form an air-control valve.
